(19) United States
(12) Patent Application Publication
(10) Pub. No.: US 2007/0283409 A1
(43) Pub. Date: Dec. 6, 2007

(54) Technique for effectively providing and presenting data concerning entertainment program viewing patterns of users through a communications network

(76) Inventor: Robert Golden, Riverside, CT (US)

Correspondence Address: STRAUB & POKOTYLO, 620 TINTON AVENUE, BLDG. B, 2ND FLOOR, TINTON FALLS, NJ, 07724, US

(21) Appl. No.: 11/446,827

(22) Filed: Jun. 5, 2006

(51) Int. Cl. H04N 7/16; H04N 7/173

(52) U.S. Cl. 725/139; 725/100; 725/131

(57) ABSTRACT

A remote processor receives from a terminal over a communications network (e.g., a cable TV network) commands relating to a presentation of programming content (e.g., fast-forward, rewind pause and select), and compiles data concerning the received commands. The data is analyzed to determine users' viewing patterns and preferences. For example, the relative popularity of various programs, say, a list of most popular TV shows (and episodes), may be determined. The list may be displayed on a user's TV screen during or immediately after a show. In addition, another list of shows (and episodes) popular among the viewers of a particular show may also be determined based on the compiled data. Such a list may be displayed on a user's TV screen during or immediately after that particular show.

### FIELD OF THE INVENTION

The invention relates to communications systems and methods, and more particularly to a system and method for collecting and analyzing data relating to user activity regarding entertainment programs provided through a communications network, e.g., a cable network.

### BACKGROUND OF THE INVENTION

With the advent of digital communications technology, many TV program streams are transmitted in digital formats. For example, Digital Satellite System (DSS), Digital Broadcast Services (DBS), and Advanced Television Standards Committee (ATSC) program streams are digitally formatted pursuant to the well known Moving Pictures Experts Group 2 (MPEG-2) standard. The MPEG-2 standard specifies, among others, the methodologies for video and audio data compressions which allow multiple programs, with different video and audio feeds, multiplexed in a transport stream traversing a single transmission channel. A digital TV receiver may be used to decode an MPEG-2 encoded transport stream, and extract the desired program therefrom.

### MPEG-2 Background

In accordance with the MPEG-2 standard, video data may be compressed based on a sequence of groups of pictures (GOPs), made up of three types of picture frames—intra-coded picture frames (“I-frames”), forward predictive frames (“P-frames”) and bilinear frames (“B-frames”). Each GOP may, for example, begin with an I-frame which is obtained by spatially compressing a complete picture using discrete cosine transform (DCT). As a result, if an error or a channel switch occurs, it is possible to resume correct decoding at the next I-frame.

The GOP may represent additional frames by providing a much smaller block of digital data that indicates how small portions of the I-frame, referred to as macroblocks, move over time.

An I-frame is typically followed by multiple P- and B-frames in a GOP. Thus, for example, a P-frame occurs more frequently than an I-frame by a ratio of about 3 to 1. A P-frame is forward predictive and is encoded from the I- or P-frame that precedes it. A P-frame contains the difference between a current frame and the previous I- or P-frame.

A B-frame compares both the preceding and subsequent I- or P-frame data. The B-frame contains the average of matching macroblocks or motion vectors. Because a B-frame is encoded based upon both preceding and subsequent frame data, it effectively stores motion information.

Thus, MPEG-2 achieves its compression by assuming that only small portions of an image change over time, making the representation of these additional frames extremely compact. Although GOPs have no relationship between themselves, the frames within a GOP have a specific relationship which builds off the initial I-frame.

The compressed video and audio data are carried by continuous elementary streams, respectively, which are broken into access units or packets, resulting in packetized elementary streams (PESs). These packets are identified by headers that contain time stamps for synchronizing, and are used to form MPEG-2 transport streams. For digital broadcasting, multiple programs and their associated PESs are multiplexed into a single transport stream. A transport stream has PES packets further subdivided into short fixed-size data packets, in which multiple programs encoded with different clocks can be carried. A transport stream not only comprises a multiplex of audio and video PESs, but also other data such as MPEG-2 program specific information (sometimes referred to as metadata) describing the transport stream. The MPEG-2 metadata may include a program associated table (PAT) that lists every program in the transport stream. Each entry in the PAT points to an individual program map table (PMT) that lists the elementary streams making up each program. Some programs are open, but some programs may be subject to conditional access (encryption) and this information is also carried in the MPEG-2 transport stream, possibly as metadata.

The aforementioned fixed-size data packets in a transport stream each carry a packet identifier (PID) code. Packets in the same elementary streams all have the same PID, so that a decoder can select the elementary stream(s) it needs and reject the remainder. Packet-continuity counters may be implemented to ensure that every packet that is needed to decode a stream is received.

In the cable TV industry, a network personal video recorder (NPVR) service has been proposed where programming content is recorded at the headend while it is being broadcast, thereby enabling users to access the recorded programming content from storage in the headend after the initial (or live) broadcast of the programming content. In addition, the NPVR service enables users to issue trick mode commands, such as “pausing”, “rewinding” and “fast-forwarding” the recorded broadcast programming content. The system architecture and design for realizing NPVR service functions are described, e.g., in copending commonly assigned application Ser. No. 10/263,015 filed on Oct. 2, 2002, hereby incorporated by reference. These trick mode commands can enhance a user's program viewing experience by, for example, enabling the user to skip or fast-forward programming content that the user does not want to view, and to rewind and repeat the display of programming content that the user would like to view again.

### SUMMARY OF THE INVENTION

The invention is premised upon a recognition of an opportunity for monitoring and analyzing user viewing activities which arises when users, e.g., NPVR service users, are allowed to access and manipulate recorded programming content at their command. In accordance with the invention, commands from user terminals are received at a remote location (e.g., a headend) through a communications network (e.g., a cable network). In response to the commands, a server in the headend affects presentations of programming content to the users at the terminals. Data is collected which concerns a subset of the received commands which relate to the users' accessing selected programs. The received commands in the subset comprise program identifiers identifying the selected programs, respectively. The collected data is analyzed to generate a viewing pattern of the users. Information concerning the viewing pattern is provided through the communications network.

In an illustrative embodiment, the viewing pattern is expressed in the form of a list enumerating shows most popular among the users. Such a list may be provided to a user while he/she is viewing a program, and the user is afforded an option to select one of the shows in the list for viewing. In another illustrative embodiment, the list contains shows most popular among viewers of a particular show. A user while or after viewing the particular show is presented with such a list from which the user may select another show for viewing.

### BRIEF DESCRIPTION OF THE DRAWING

Further objects, features and advantages of the invention will become apparent from the following detailed description taken in conjunction with the accompanying drawing showing illustrative embodiments of the invention, in which:

FIG. 1 is a block diagram of a communications system in accordance with an embodiment of the invention;

FIG. 2 illustrates a TV program comprising multiple program segments which is provided in the system of FIG. 1;

FIG. 3 illustrates a request for recorded program material from a set-top terminal in the system of FIG. 1;

FIG. 4 is a flow chart depicting a process for providing recorded program material in response to the request of FIG. 3;

FIG. 5 is a block diagram of a proxy server included in the system of FIG. 1;

FIG. 6 illustrates selected carriers for transmitting recorded program materials in a forward passband of the system of FIG. 1;

FIG. 7 is a flow chart depicting a process for pausing a recorded program in response to a pause message from a set-top terminal;

FIG. 8 is a flow chart depicting a process for rewinding a recorded program in response to a rewind message from a set-top terminal;

FIG. 9 is a flow chart depicting a process for fast-forwarding a recorded program in response to a fast-forward message from a set-top terminal;

FIG. 10 is a flow chart depicting a process for collecting data relating to user activity respecting programming content in accordance with an embodiment of the invention;

FIG. 11 illustrates a record of a command initiated by a user at a set-top terminal;

FIG. 12 illustrates a table tabulating user command records;

FIG. 13 illustrates a user activity database generated by a data analyzer;

FIG. 14 illustrates a show table mapping assets to different shows;

FIG. 15A illustrates a screen presentation of popular shows in accordance with the invention;

FIG. 15B illustrates a screen presentation of popular episodes pertaining to a selected show in FIG. 15A;

FIGS. 16A and 16B are flowcharts jointly depicting a routine for determining the relative popularity of various shows and their episodes;

FIG. 17 illustrates an asset popularity table resulting from executing the routine of FIGS. 16A and 16B;

FIG. 18 illustrates a show popularity table resulting from executing the routine of FIGS. 16A and 16B;

FIGS. 19A and 19B are flowcharts jointly depicting a routine for identifying shows and their episodes that are popular among viewers of a selected TV show; and

FIG. 20 illustrates a conditional asset popularity table resulting from executing the routine of FIGS. 19A and 19B; and

FIG. 21 illustrates a conditional show popularity table resulting from executing the routine of FIGS. 19A and 19B.

### DETAILED DESCRIPTION

The invention is directed to collecting and analyzing data relating to users' viewing patterns in a communications network, and further directed to presenting the analyzed results to users in an effective and user-friendly format. For example, in accordance with an embodiment of the invention, a user of a cable network may select a desired program for viewing. While the user is viewing the program, a network controller in the cable operator's headend facility may cause a list of TV shows that are popular among the network's subscribers to be displayed on the user's television screen. For example, a list of the ten shows that were most popular during the previous week may be displayed. The list may be shown during a commercial break, or immediately after a program ends. Alternatively, a list of popular programs may be shown during the presentation of the program, e.g., in the lower left hand corner of the television screen.

In another embodiment, when a user selects a program for viewing, the network controller causes a list of TV shows that are popular among other subscribers who have watched the selected program to be displayed on the user's television screen. Thus, for example, if a user selects the program “Everybody Loves Raymond (ELR)” to view, the network controller may cause a list of TV shows that are popular among other viewers of ELR to be presented on the user's television screen, thereby suggesting shows which may interest the user for the user to watch after the current ELR program.

As described above, an aspect of the invention is directed to analysis and presentation of information concerning user activity with respect to programming content (e.g., TV shows) in a broadband communications system. The latter may provide network personal video recorder (NPVR) service, including service functions responsive to trick mode commands (such as pausing, rewinding, fast-forwarding, etc.) for manipulating the presentation of programming content. As described below, the communications system is configured for recording broadcast programming content for subsequent review in accordance with the NPVR service. That is, the NPVR service enables a user to access programming content, albeit recorded at the headend, after its initial broadcast. Thus, the user may view an initial broadcast program in real-time and/or access a recording of such a program sometime after its initial broadcast. The aforementioned manipulation commands can be used to enhance a user's program viewing experience by, for example, enabling the user to fast-forward programming content that the user does not want to view, and to rewind and repeat the display of programming content that the user would like to view again.

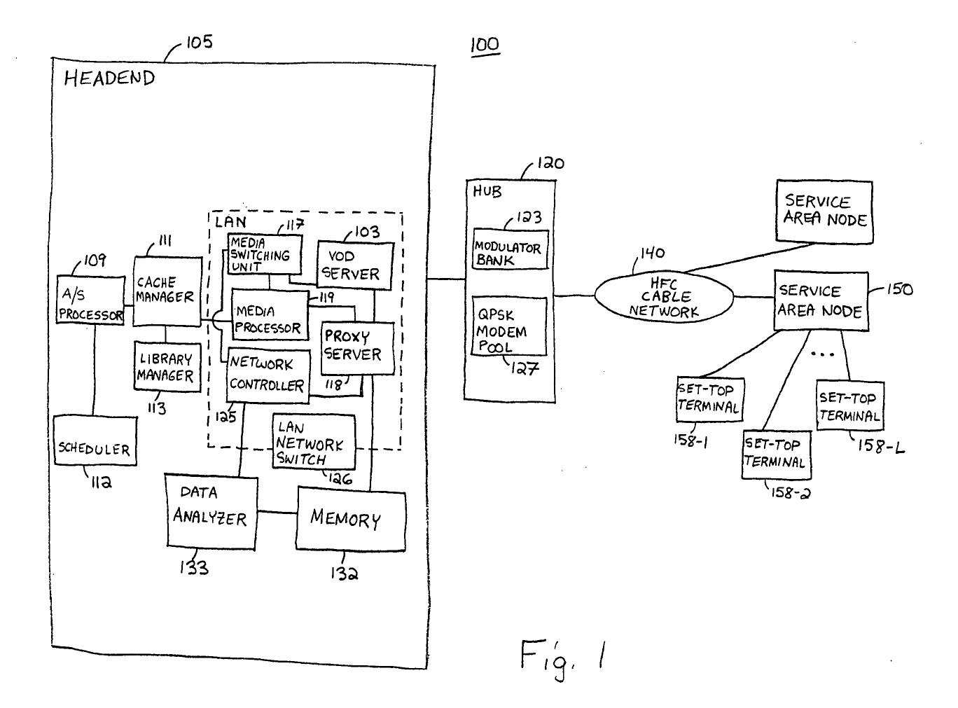

FIG. 1 illustrates broadband communications system 100 which, among other things, receives programming content, records the programming content, provides interactive programming and services to users, receives commands from users for accessing and manipulating programming content, and collects and analyzes information relating to such access and manipulation activity.

For example, system 100 in this instance includes a cable system for delivering, in accordance with the invention, information and entertainment programs to set-top terminals on the user premises. As shown in FIG. 1, system 100 includes headend 105, hub 120, hybrid fiber coax (HFC) cable network 140 and different service area nodes including node 150, which in this instance is connected to set-top terminals 158-1 through 158-L in a neighborhood, where L represents an integer.

Headend 105 receives programs and services from various providers and sources, e.g., analog and digital satellite sources, application servers, media servers, the Internet, etc. Analog and digital satellite sources typically provide the traditional forms of television broadcast programs and information services. Application servers typically provide executable code and data for application specific services such as database services, network management services, transactional electronic commerce services, system administration console services, application specific services (such as stock ticker, sports ticker, weather and interactive program guide data), resource management service, connection management services, subscriber cares services, billing services, operation system services, and object management services. Media servers provide time-critical media assets such as MPEG-2 encoded video and audio, MPEG-2 encoded still images, bit-mapped graphic images, PCM digital audio, three dimensional graphic objects, application programs, application data files, etc. Although specific examples of programs and services which may be provided by the aforementioned sources are given herein, other programs and services may also be provided by these or other sources without departing from the spirit and scope of the invention.

### Receiving Programming Content and Creating Assets

Acquisition/Staging (A/S) processor 109 in headend 105 processes program materials including, e.g., TV program streams, from one or more of the aforementioned sources in analog and digital forms. Analog TV program streams may be formatted according to the National Television Standards Committee (NTSC) or phase alternating line (PAL) broadcast standard. Digital TV streams may be formatted according to the Digital Satellite System (DSS), Digital Broadcast Services (DBS), or Advanced Television Standards Committee (ATSC) standard. Processor 109, among other things, extracts program content in the analog and digital TV streams and reformats the content to form one or more MPEG-2 encoded transport streams. Such reformatting may even be applied to those received streams already in an MPEG-2 format. This stems from the fact that the digital content in the received MPEG-2 streams are typically encoded at a variable bit rate (VBR). To avoid data burstiness, processor 109 in a conventional manner re-encodes such digital content at a constant bit rate (CBR) to form the aforementioned transport streams.

An MPEG-2 transport stream contains multiple program streams with different video and audio feeds multiplexed for transmission through the same transmission channel. The program streams representing individual programs are identified by respective program identifications (IDs) within a transport stream. It should be noted at this point that the term “transmission channel” should not be confused with a “program channel.” A “transmission channel” signifies a designated frequency band through which a transport stream is transmitted. On the other hand, a “program channel” signifies the source of the program material selected by a user to view. For example, a user may select program channel 2 to view initial broadcast program material provided by CBS; program channel 14 to view initial broadcast program material provided by ESPN; program channel 32 to view initial broadcast program material provided by MTV, etc.

In this illustrative embodiment, the transmission channels, each carrying a transport stream, may be 6 MHz bands populating a forward passband, e.g., 350-750 MHz band, of a coaxial cable, which is allocated for downstream communication from headend 105 to a set-top terminal.

A/S processor 109 may receive “assets” including pre-staged movie videos, news reports, sports events, etc. from content providers. However, in accordance with the invention, processor 109 may also create “assets” in real time while processing received program materials which are not pre-staged by the content providers. In general, an “asset” is a container for, or a reference (e.g., a pointer) to, any object or set of objects that may be desired to implement a service, including video, audio, images, application executables, scripts, configuration files, text, fonts, and HTML pages. In addition to the raw content, metadata (not to be confused with MPEG-2 metadata) is also a part of an asset object that describes characteristics of the asset. For example, asset metadata may describe attributes that are inherent in the content of the asset, such as the rating, format, duration, size, or encoding method. Values for asset metadata are determined at the time the asset is created.

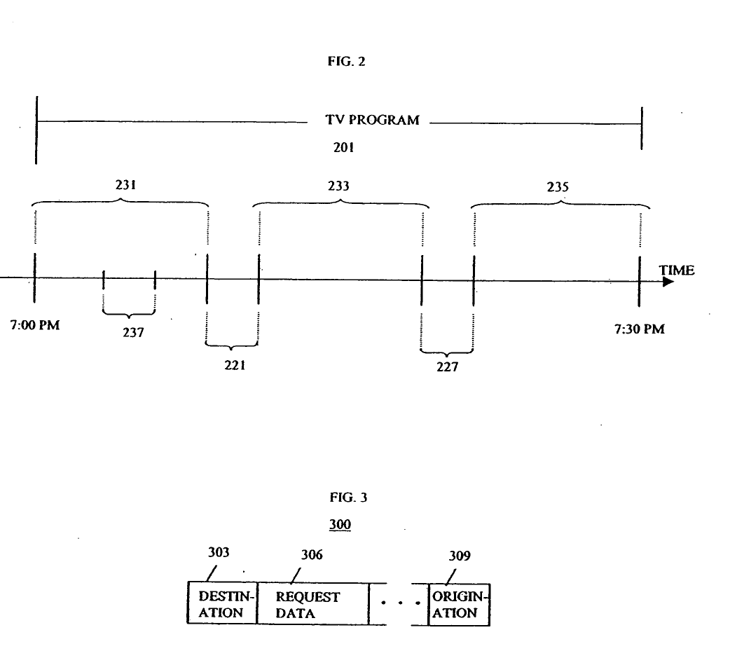

In this illustrative embodiment, an asset concerning a program includes a metadata file and trick files associated with the program, in addition to the program content contained in a transport stream. FIG. 2 illustrates TV program 201 which spans from 7:00 p.m. to 7:30 p.m. Program 201 comprises a show interrupted by commercials, which is typical. Thus, the program content in this instance consists of show segments 231, 233 and 235, interleaved with commercial segments 221 and 227.

In accordance with an aspect of the invention, the TV program streams received by processor 109 are pre-processed, e.g., by the providers, to include indicators, e.g., cue-tones, on which processor 109 relies to identify the demarcations (or edges) of different programs and program segments within each program. Thus, in this instance before processor 109 processes the TV program stream containing TV program 201, a first cue-tone has been inserted at the beginning of segment 231, indicating the beginning of TV program 201; second cue-tones have been inserted at the beginnings of segments 221 and 227, indicating the beginnings of the respective commercial segments; third cue-tones have been inserted at the ends of segments 221 and 227, indicating the ends of the respective commercial segments; and a fourth cue-tone has been inserted at the end of segment 235, indicating the end of TV program 201. In accordance with another aspect of the invention, another set of cue-tones may be inserted to delimit a “chapter” (denoted 237) within a program. A chapter is a self-contained subprogram, e.g., a skit, monolog, song performance, news report, weather report, etc. within a program. With the cue-tones defining one such chapter, processor 109 is capable of identifying the chapter and create an asset concerning the same.

Let's assume that TV program 201 in this instance is an initial broadcast program. Processor 109, among other things, collects in a database (not shown) program guide data associated with different TV programs which are not pre-staged (including TV program 201 in this instance) from an application server, which may be different from the sources of the TV programs themselves, such as scheduler 112. Each program when presented to processor 109 is identified by a program designation, which may be used to locate the corresponding program guide data. In particular, processor 109 while processing TV program 201 may locate the corresponding program guide data from scheduler 112 to create in real time the metadata file associated with TV program 201. The metadata file thus created includes such data as the title, rating (e.g., G, PG-13, R, etc.), names of the producer, director, and actors, duration of the program, program type (e.g., situation comedy), etc.

Processor 109 may also create in real time trick files associated with program 201 as part of the asset which are used to perform trick mode functions (e.g., rewinding and fast-forwarding) on program 201 in accordance with the invention. One such trick file in this instance is a “fast-forward” trick file which contains an array of identifiers of I-frames in the program stream (MPEG-2 encoded as mentioned before) corresponding to program 201 in a forward direction. Another trick file is a “rewind” trick file which contains an array of identifiers of I-frames in the program stream corresponding to program 201 in the reverse direction. The I-frame identifiers in the trick files are used as indices or markers for rewinding and fast-forwarding of program 201. It should be noted that not all of the I-frames associated with program 201 are selected for the trick files. Rather, the I-frames are selected periodically along the program stream. Thus, the shorter the period is, the closer the instants from which program 201 can be rewound, and to which program 201 can be fast-forwarded, thereby achieving finer adjustments.

It should be noted that where program 201 is not an initial broadcast program, which may also be pre-staged, commercial segments 221 and 227 may not contain the commercials originally provided by the program provider. Rather, program 201 may be repackaged with after-market commercials, which may be targeted to the user, and which may even be injected anywhere in the program with no regard for original segments 221 and 227 in terms of their timing, duration, or quantity. In the event that program 201 is pre-staged, the program content comes with the corresponding metadata file and trick files associated with the program. Processor 109 stores the created or pre-staged asset including the metadata file and trick files associated with a program according to its program designation in asset storage (not shown), which may reside in library manager 113 described below.

The transport streams generated by processor 109, which contain live TV programs in this instance, are fed to cache manager 111. The latter includes a cache memory (not shown), e.g., a disk cache, having a memory capacity on the order of terabytes. Manager 111 copies the transport streams onto the cache memory, and also forwards the same to library manager 113 for long-term storage. The latter includes library storage having a memory capacity on the order of hundreds of terabytes, much larger than that of the cache memory such that the cache memory stores the last Y hours' worth of the TV programs while the library storage stores the last Z hours' worth of the TV program, where the value of Z is much greater than that of Y. It suffices to know for now that use of the cache memory, which affords faster access to its content than the library storage, facilitates a speedy retrieval of a requested program in the event of a “cache hit,” i.e., the requested program being within the last Y hour broadcast. Otherwise, a “cache miss” causes locating the requested program in the library storage, thereby incurring a delay in the retrieval of the program.

### Transmission Set-Up Receiving User Requests, And Transmission of Content

Network controller 125, among others, assigns resources for transporting program materials to set-top terminals and communicates various data including system information with the terminals. Upstream data from a set-top terminal to network controller 125 is communicated via a reverse passband, e.g., 5-40 MHz band, of a coaxial cable. The reverse passband comprises reverse data channels (RDCs) having a 1 MHz bandwidth in this instance, through which quaternary phase shift keying (QPSK) signals containing upstream data are transmitted. It should be noted that the 1 MHz bandwidth allocated for an RDC here is for illustrative purposes only. It will be appreciated that a person skilled in the art may allocate other bandwidths therefor depending on the actual implementations. A set-top terminal utilizes an RDC for sending both application data and control messages. For example, the Digital Audio Visual Council (DAVIC), a standard setting organization, has defined a contention-based access mechanism whereby multiple set-top terminals share an RDC. This mechanism enables the set-top terminals to transmit upstream messages without a dedicated connection to a QPSK demodulator. The mechanism also provides equal access to the set-top terminals that share the RDC, and enables detection and recovery from reverse path collisions that occur when two or more of the terminals transmit an upstream message simultaneously. As also specified by DAVIC, for communications purposes, the set-top terminals and network controller 125 are identified by the Internet protocol (IP) addresses assigned thereto. However, these IP addresses may be randomly assigned each time when system 100 is reconfigured. As a result, the IP address of a set-top terminal or controller 125 may change after a system reconfiguration. Nevertheless, each set-top terminal and controller 125 is also assigned a media access control (MAC) address on a permanent basis, surviving any system reconfiguration.

Downstream data from network controller 125 to a set-top terminal is communicated via forward data channels (FDCs). These channels, often referred to as “out-of-band” channels, may occupy the 70-130 MHz band of a coaxial cable. QPSK signals containing system messages to a set-top terminal are transmitted through an FDC having a 1 MHz bandwidth in this instance. It should be noted that the 1 MHz bandwidth allocated for an FDC here is for illustrative purposes only. It will be appreciated that a person skilled in the art may allocate other bandwidths therefor depending on the actual implementations.

When a user at a set-top terminal, say, terminal 158-1, turns on the TV associated therewith and selects a particular program channel, say, program channel 2, or change from another channel to channel 2, terminal 158-1 in a well known manner scans for any transport streams transporting programs to the neighborhood. In system 100, each transport stream is identified by a unique transport stream identification (TSID).

Continuing the above example, once the TSIDs of the transport streams are detected, terminal 158-1 sends through QPSK modem pool 127 a request for program channel 2 material. FIG. 3 illustrates one such request (denoted 300) sent from a set-top terminal to network controller 125 via an RDC. As shown in FIG. 3, request 300 includes, among others, destination field 303 which in this instance contains the IP address of network controller 125 to which request 300 is destined; request data field 306 which contains data concerning the detected TSIDs and the requested program channel material, e.g., program channel 2 material in this instance; and origination field 309 which in this instance contains the IP (and/or MAC) address of terminal 158-1 from which request 300 originates.

It should be noted at this point that, in addition to requesting initial broadcast programming content through the selection of a channel—i.e., recorded content that is currently being broadcast over a program channel in real-time or close to real-time (also referred to as live broadcast programming and in-progress programming)—a user may also request programming content that has already been broadcast and which is recorded and stored by headend 105. Such recorded programming content may be accessed by, for example, issuing a program selection through an electronic program guide (EPG) or some other graphical user interface (GUI) configured for the access of programming content for such recorded content from set-top terminal 158 as part of the aforementioned NPVR service.

A communication protocol used by a set-top terminal for transmitting to headend 105 a selected command to request desired received programming content, and other commands to pause, rewind and fast-forward, is well known in the art, and an example of one such protocol used for such commands is described in “Lightweight Stream Control Protocol,” Time Warner Cable, Ver. 1.0, Jun. 10, 1999.

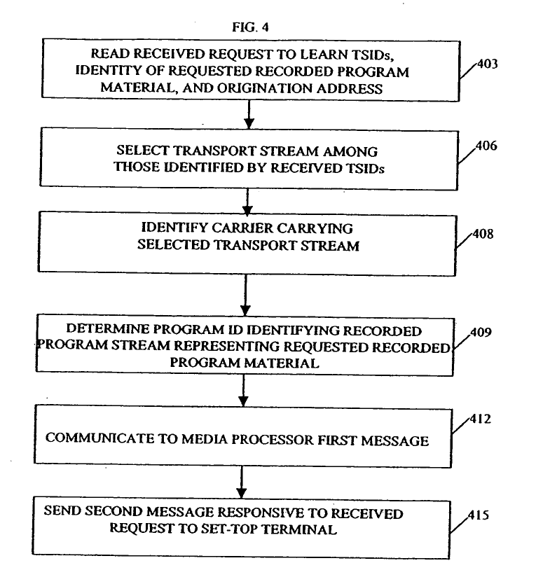

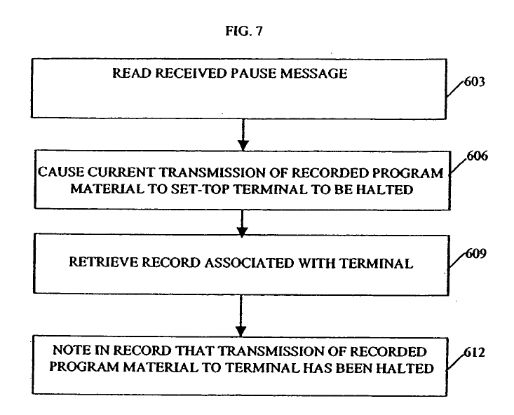

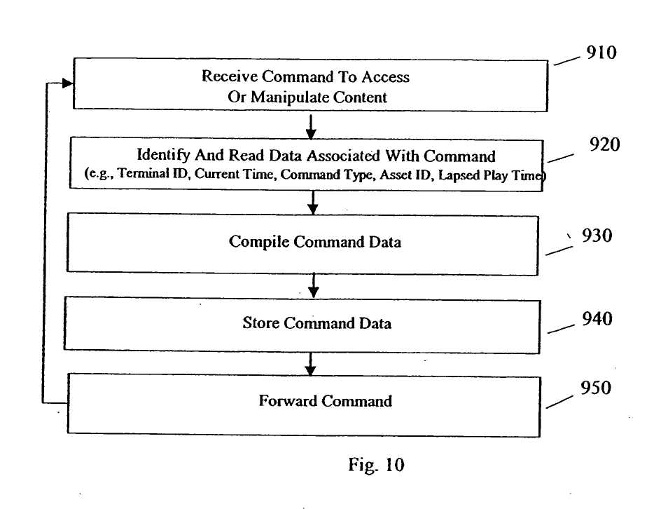

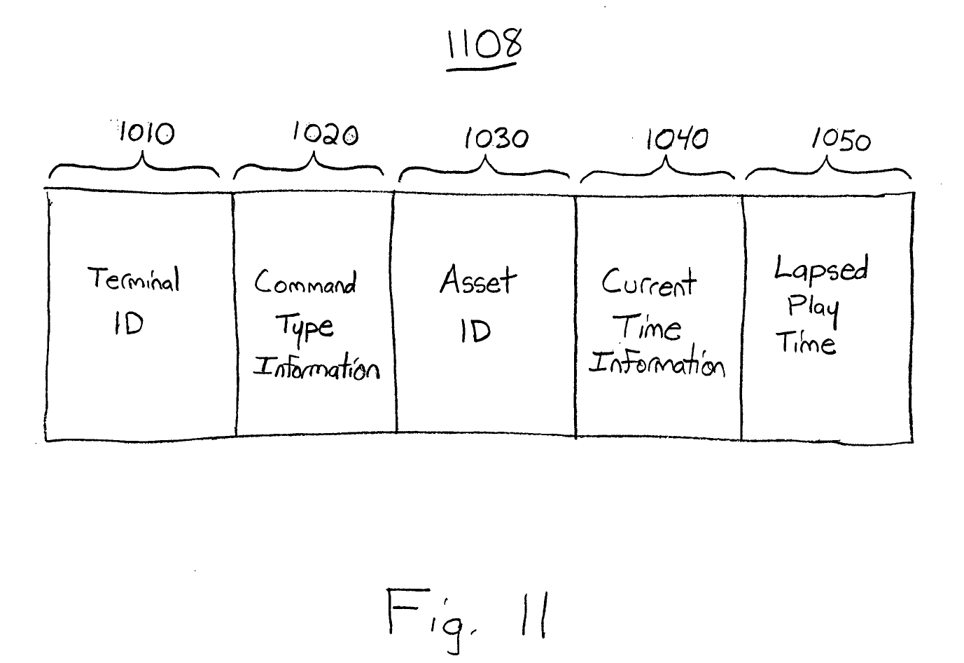

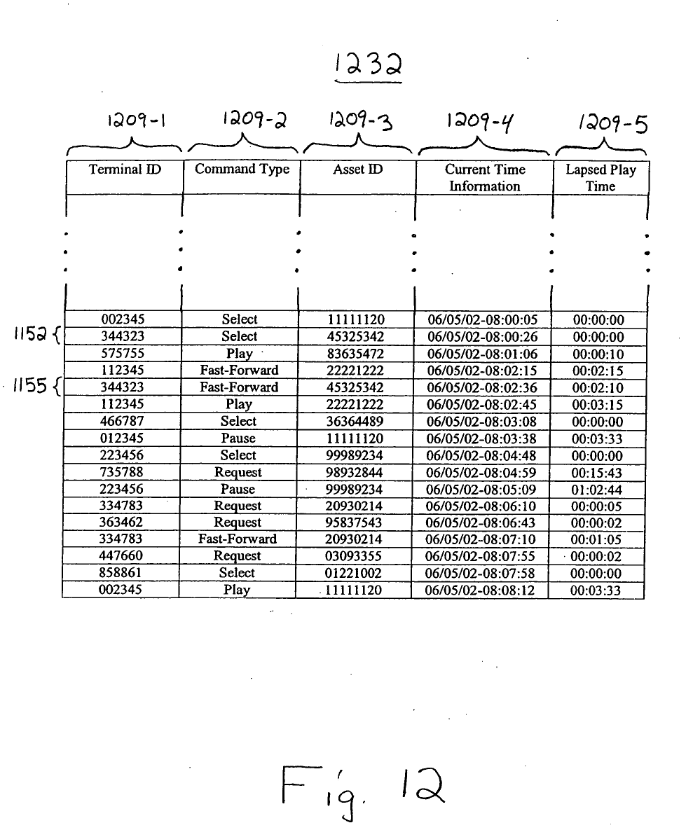

After receiving request 300, network controller 125 reads the received request to learn the TSIDs, the identity of the requested program material, and the origination address therein, as indicated at step 403 in FIG. 4. In an embodiment of the invention, proxy server 118 is located in headend 105 and is in communication with network controller 125 and media processor 119. In accordance with an embodiment of the invention, proxy server 118 is configured for reading and forwarding information relating to each program request or selection, as well as each manipulation command, examples of which are described below with reference to FIGS. 7-9. The information captured by proxy server 118 is also described below, with reference to FIGS. 10 and 11.

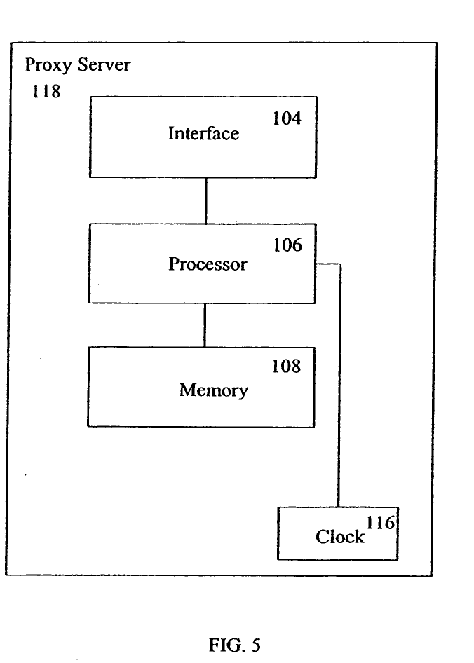

Referring to FIG. 5, proxy server 118 illustratively is comprised of interface 104, processor 106 and memory 108. Interface 104 is configured for receiving data from set-top terminal 158-1 associated with user commands, reading such commands and passing the commands onto media processor 119, without modifying the received commands. Processor 106 is configured for, among other things, compiling the data relating to the received commands and memory 108 stores the received command data. Proxy server 118 also includes clock 116, synchronized with the system clock, for generating current date and time information as described below. The type of data that is read, compiled and stored, and the process for doing so, are described more fully below.

In one embodiment, proxy server 118 may additionally store data relating to received commands in memory 132. The data may be stored, for example, in a database in memory 132. In this embodiment, data analyzer 133 may access and analyze the data stored in memory 132 to provide useful information concerning the viewing habits of users. Such information may be provided directly to users or may be utilized by the cable operator.

In response to received request 300, network controller 125 communicates with media processor 119 through proxy server 118 to determine the capacity required for transmitting the requested program material. Based on the required capacity, controller 125 at step 406 selects a transport stream among those identified by the received TSIDs which is suitable for transporting the requested program material. Controller 125 at step 408 identifies the carrier carrying the selected transport stream.

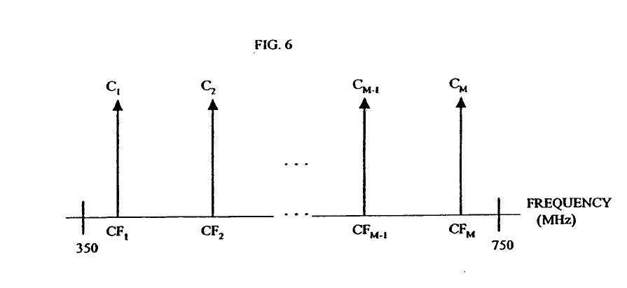

Referring also to FIG. 1, modulator bank 123 in this instance is located in hub 120 connected to headend 105 via IP transport on the one hand and to HFC cable network 140 on the other hand. Bank 123 includes multiple modulators, each of which is used to modulate transport streams onto different carriers. Each modulated carrier carrying a transport stream is transmitted through a transmission channel associated therewith. FIG. 6 illustrates M carriers, C₁ through C_{M}, associated with M transmission channels in the forward passband. As shown in FIG. 6, the carrier frequency of C₁ is denoted CF₁; the carrier frequency of C₂ is denoted CF₂; . . . ; and the carrier frequency of C_{M} is denoted CF_{M}. In this example, each program stream may contain 4.2 Mb/s video and audio program data. By using a 256-quadrature-amplitude-modulation (256-QAM) technique and 6 MHz transmission channel, each modulator in modulator bank 123 in this instance may modulate up to 9 program streams, multiplexed in a transport stream, onto the corresponding carrier. The resulting modulated carrier is transmitted through the transmission channel associated with the carrier.

Network controller 125 may include therein a carrier assignment table which lists, for each carrier, the TSID of the transport stream carried thereby. The carrier identification by network controller 125 at aforementioned step 408 may be achieved by looking up from the table the carrier associated with the TSID of the selected transport stream. Based on the requested program channel (for a request of a live program) or the requested recorded program identified by a user's command to play such program, network controller 125 at step 409 determines the program ID identifying the program stream representing the requested program material, which is then multiplexed with other program streams in the selected transport stream. At step 412, network controller 125 communicates to media processor 119 through proxy server 118 a first message containing the identity of the modulator in modulator bank 123 which corresponds to the carrier, say, C₁, just determined, and the program ID associated with the requested program material just determined. Network controller 125 at step 415 sends, through QPSK modem pool 127, a second message responsive to the received request to set-top terminal 158-1 identified by the origination IP (and/or MAC) address in field 309 of request 300. This second message traversing an FDC contains the information concerning the carrier frequency, i.e., CF₁ in this instance, to which terminal 158-1 should tune to receive the appropriate transport stream, and the program ID for extracting the desired program stream within the transport stream.

In response to the first message, processor 119 directs cache manager 111 to deliver a copy of the program stream representing the requested program material thereto and causes the program stream to be multiplexed with any other program streams already in the transport stream identified by the selected TSID. In addition, processor 119 causes media switching unit 117 to switch the resulting transport stream to the modulator corresponding to the carrier C₁. Accordingly, the modulator modulates the carrier C₁ with the received transport stream, and causes transmission of the modulated carrier through the transmission channel associated with CF₁.

Based on the information in the second message, terminal 158-1 tunes to the carrier frequency CF₁ to receive the transmitted transport stream, and extracts therefrom the desired program stream, representing the requested program material in this instance. In a well known manner, terminal 158-1 converts the extracted program stream to appropriate signals for the associated TV to play the requested program material.

While the requested program material is being played, terminal 158-1 continuously registers the last I-frame identifier in the received transport stream. From time to time, terminal 158-1 sends a “heartbeat” containing the IP (and/or MAC) address identifying terminal 158-1 and the last I-frame identifier to media processor 119. Processor 119 keeps, for terminal 158-1, a record identified by the IP (and/or MAC) address of terminal 158-1, and tracks the program being transmitted to terminal 158-1 and its I-frame progress. When processor 119 no longer receives heartbeats from terminal 158-1, e.g., because of an off state of the terminal, processor 119 may cause the transmission of the transport stream to terminal 158-1 to be halted.

It should be noted that in this illustrative embodiment, media switching unit 117, media processor 119, network controller 125, VOD server 103 and proxy server 118 are in communication with one another via a local area network (LAN) 101 in headend 105. For example, LAN 101 may be an Ethernet. Media switching unit 117, media processor 119, network controller 125, VOD server 103 and proxy server 118 of headend 105, in this instance, are connected to LAN switch 126 and are thereby in communication with one another through LAN 101. The data communicated between these headend components in the manner described above is routed through switch 126 based on the processing instructions therein and routing information associated with the data.

### Pause Command

When the user issues a pause command to terminal 158-1, e.g., by pressing a “pause” key on a remote control associated therewith to temporarily stop the progress of the program, terminal 158-1 issues a pause message to media processor 119 identified by its IP address. The process for pausing programming content is described below with reference to FIG. 7. The pause message in this instance includes a pause initiation command, the last I-frame identifier registered by terminal 158-1, and the IP and/or MAC address of terminal 158-1. After issuing the pause message, terminal 158-1 enters a pause state and causes the picture corresponding to the next I-frame, say I-frameₚₐᵤₛₑ, to be frozen on the TV screen, thereby achieving the pause effect. The pause message, however, passes through proxy server 118 before it reaches processor 119, in accordance with the invention. Processor 119 reads the received pause message, as indicated at step 603 in FIG. 7. Processor 119 at step 606 causes the current transmission of the program material to set-top terminal 158-1 (identified by the received IP and/or MAC address) to be halted at the I-frame immediately following the last I-frame identified in the received message. Processor 119 at step 609 retrieves the record associated with terminal 158-1. Processor 119 at step 612 notes in the record that the transmission of the program material to terminal 158-1 has been halted at I-frameₚₐᵤₛₑ.

When the user issues a command to resume viewing the program material, e.g., by toggling the pause key on the remote control, terminal 158-1 exits the pause state, sends a resumption message to processor 119, and readies itself to receive the program material starting from I-frameₚₐᵤₛₑ. This resumption message includes a resumption command, and the IP and/or MAC address of terminal 158-1. The resumption message passes through proxy server 118 before it reaches processor 119, in accordance with the invention. Processor 119 then retrieves the record associated with terminal 158-1 identified by the received IP and/or MAC address. In response to the resumption command, processor 119 causes the transmission of the program material to terminal 158-1 to be restarted from I-frameₚₐᵤₛₑ, and notes in the record the transmission resumption event. As a result, terminal 158-1 resumes receiving the program material in the same program stream delivered thereto before. It should be noted that use of a MAC address, instead of an IP address, to identify terminal 158-1 may be advantageous here especially when the pause state is long, so much so that a reconfiguration of system 100 may have occurred during such a state. In that case, the IP address identifying terminal 158-1 before the system reconfiguration may be different than that after the reconfiguration, and as a result, by using only the pre-reconfiguration IP address of terminal 158-1 for its identification, the resuming program stream would not be delivered to the intended terminal 158-1 after the reconfiguration. On the other hand, since the MAC address of terminal 158-1 is immutable and survives any system reconfiguration, by relying on the MAC address of terminal 158-1 for its identification here, the resuming program stream would be correctly delivered to terminal 158-1 even after a system reconfiguration.

### Rewind Command

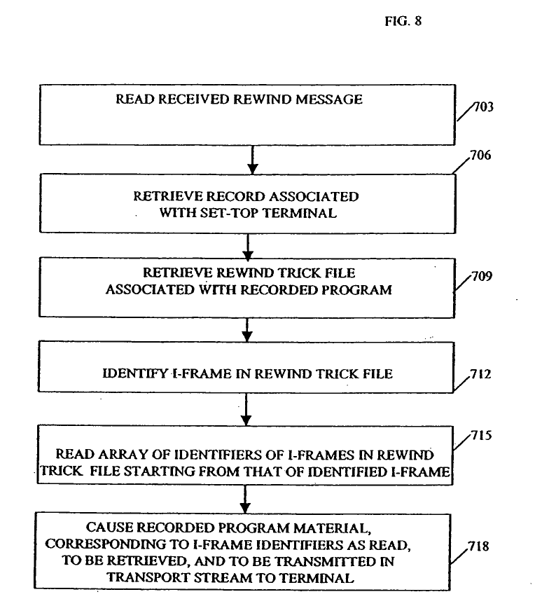

While viewing a program, the user may issue a rewind command, e.g., by pressing a rewind key on the remote control, to rewind the program. In that case, terminal 158-1 issues a rewind message to processor 119 identified by its IP address. This rewind message includes a rewind initiation command, the last I-frame identifier registered by terminal 158-1, and the IP address (and/or MAC address) identifying terminal 158-1. Such a rewind message, however, passes through proxy server 118 before it reaches processor 119, in accordance with the invention. Processor 119 then reads the received rewind message as indicated at step 703 in FIG. 8. Processor 119 at step 706 retrieves the record associated with set-top terminal 158-1 identified by the received IP address (and/or MAC address). Knowing from the record the identity of the program being transmitted, processor 119 at step 709 retrieves from the aforementioned asset storage the rewind trick file associated with the program. Based on the last I-frame information in the received message, processor 119 at step 712 identifies the I-frame in the rewind trick file which either matches or is the closest to that last I-frame. Processor 119 at step 715 reads the array of identifiers of the I-frames in the rewind trick file starting from that of the identified-I-frame. Processor 119 at step 718 causes the program material, corresponding to the I-frame identifiers as read, to be retrieved from cache manager 111, and to be transmitted in the transport stream to terminal 158-1, thereby achieving the desired rewind effect.

When the user issues a command to stop rewinding the program, e.g., by toggling the rewind key on the remote control, terminal 158-1 sends a rewind termination message to processor 119. This message includes a rewind termination command, and the IP address (and/or MAC address) of terminal 158-1. The message passes through proxy server 118 before it reaches processor 119, in accordance with the invention. In response to the rewind termination command, processor 119 stops reading the rewind trick file associated with the program. Processor 119 learns from the record associated with terminal 158-1 the last I-frame identifier read from the rewind trick file. Processor 119 causes retrieval of the program material at the normal forward speed from cache manager 111 starting from the I-frame identified by the last read identifier, and transmission of the retrieved program material to terminal 158-1. As a result, terminal 158-1 resumes receiving the program material at the normal forward speed in the same transport stream.

### Fast-Forward Command

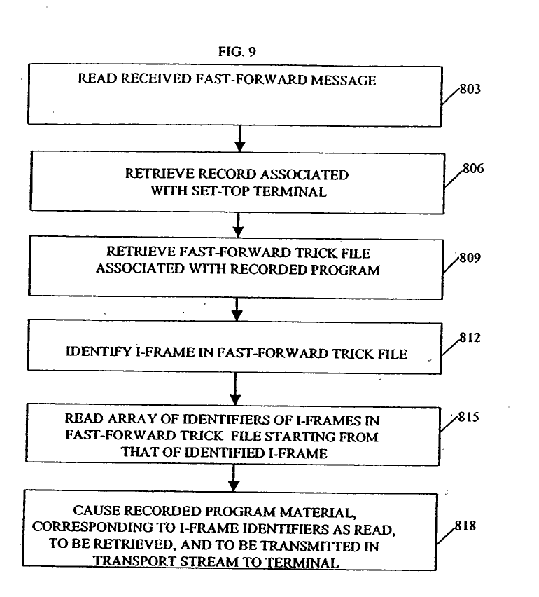

While viewing a recorded program, the user may issue a fast-forward command, e.g., by pressing a fast-forward key on the remote control, to fast-forward the program. In that case, terminal 158-1 issues a fast-forward message to processor 119 identified by its IP address. This fast-forward message includes a rewind initiation command, the last I-frame identifier registered by terminal 158-1, and the IP address (and/or MAC address) identifying terminal 158-1. Such a fast-forward message, however, passes through proxy server 118 before it reaches processor 119, in accordance with the invention. Processor 119 then reads the received fast-forward message, as indicated at step 803 in FIG. 9. Processor 119 at step 806 retrieves the record associated with set-top terminal 158-1 identified by the received IP address (and/or MAC address). Knowing from the record the identity of the program being transmitted, processor 119 at step 809 retrieves from the aforementioned asset storage the fast-forward trick file associated with the program. Based on the last I-frame information in the received message, processor 119 at step 812 identifies the I-frame in the fast-forward trick file which either matches or is the closest to that last I-frame. Processor 119 at step 815 reads the array of identifiers of the I-frames in the fast-forward trick file starting from that of the identified I-frame. Processor 119 at step 818 causes the program material, corresponding to the I-frame identifiers as read, to be retrieved from cache manager 111, and to be transmitted in the transport stream to terminal 158-1, thereby achieving the desired fast-forward effect.

When the user issues a command to stop fast-forwarding the program, e.g., by toggling the fast-forward key on the remote control, terminal 158-1 sends a fast-forward termination message to processor 119. This message includes a fast-forward termination command, and the IP address (and/or MAC address) of terminal 158-1. The message passes through proxy server 118 before it reaches processor 119, in accordance with the invention. In response to the fast-forward termination command, processor 119 stops reading the fast-forward trick file associated with the program. Processor 119 learns from the record associated with terminal 158-1 the last I-frame identifier read from the fast-forward trick file. Processor 119 causes retrieval of the program material at the normal forward speed from cache manager 111 starting from the I-frame identified by the last read identifier, and transmission of the retrieved program material to terminal 158-1. As a result, terminal 158-1 resumes receiving the program material at the normal forward speed in the same transport stream.

### Monitoring User Activity

As described above, proxy server 118 collects information relating to program requests, program selections and manipulation commands that are received by headend 105. The collected information is then stored and made available for tracking user activity respecting programming content provided over system 100.

FIG. 10 is a flowchart depicting a process for collecting data relating to user activity respecting programming content transmitted by system 100, in accordance with an embodiment of the invention.

In steps 910 and 920, each time a user issues a command to access or manipulate recorded programming content, interface 104 of proxy server 118 receives the command (step 910). Server 118 identifies and reads (step 920) data associated with the program request, program selection or manipulation command. Proxy server 118 is programmed to read certain data associated with the issued command.

The read data relates to, in accordance with an embodiment of the invention, Terminal Identification information (Terminal ID), Command Type Information, Asset Identification (ID) and Current Time Information. Terminal ID identifies the set-top terminal, e.g., its MAC address, from which the command is transmitted to headend 105. By identifying the terminal ID, additional information may be further obtained, such as the location (neighborhood or billing address) of the set-top terminal, the identity of the cable service subscriber at the terminal and the like. Such additional information is stored in one or more databases (not shown), e.g., a billing data database.

Command Type information includes an indication of the type of command that is issued by a user and received at headend 105. These commands include, e.g., request, select, pause, stop, play, rewind and fast-forward commands.

Asset ID (such as a numeric or alphanumeric string) may be used to identify the asset that the user is accessing or manipulating. When a previously broadcast program (that has been recorded), identified by an Asset ID, is selected or manipulated by a user at, say, set-top terminal 158-1, the selection triggers transmission of the Asset ID associated with the selection. Asset ID is then transmitted to headend 105 as part of the user's selection or manipulation command. However, an in progress broadcast program at a given time is identified based on the time in question and program channel to which terminal 158-1 is tuned. This is accomplished by transmitting to scheduler 112 current time and selected channel information respecting the requested programming content. Scheduler 112 receives information relating to the time that a program is scheduled to broadcast. Programming schedule data may be received from, for example, an electronic program guide (EPG) server (not shown), and includes a program identification code for each program and the start time respecting each program. For an in-progress program, Asset ID would be replaced by the analogous program identification.

In accordance with an embodiment of the invention, proxy server 118 includes clock 116 for generating current date and time information (referred hereinafter as Current Time Information) when a program request, program selection or manipulation command is received. In another embodiment of the invention, Current Time Information may be generated and transmitted by set-top terminal 158-1 as part of a program request, program selection or manipulation command data to be read by proxy server 118.

Proxy server 118 further identifies data that is associated with the programming content for which a user command is received. As described above, an asset is designated a unique Asset ID and this information is obtained by interface 104 of proxy server 118 when a user issues a program request, program selection or manipulation command. Once the proxy server 118 identifies the Asset ID of the asset for which a request, selection or manipulation command was received, proxy server 118 accesses session data to, among other things, identify the point within the asset the user issued the request, selection or command. In accordance with an embodiment of the invention, this point may be identified in terms of the difference in time, at normal play speed, between the beginning of an asset and the point within the asset in which a user-issued command has been received. This measurement of time—referred to herein as Lapsed Play Time—may be obtained by identifying the user-accessed asset's Normal Play Time (NPT). NPT is a value associated with an accessed asset which advances in real-time in normal play mode, advances faster than real-time when the asset is fast-forwarded, decrements when the asset is rewound and is fixed when the asset is paused. Thus, if a user selects an asset for display and watches it for, let's say, exactly five minutes, an NPT value of 0 hours, 5 minutes and 0 second is generated by the server or processor (e.g., media processor 119) that is providing the content from headend 105 to set-top terminal 158. This value is also read by proxy server 118 for a received command.

Once the data for a received command is read, processor 106 then compiles the associated data (step 930) for storage (step 940). In one embodiment, data associated with a received command is compiled and stored together in a file or record (referred to as a “command record”). FIG. 11 illustrates schematically a command record 1108 comprising field 1010 which contains Terminal ID data, field 1020 which contains Command Type Information, field 1030 which contains Asset ID data, field 1040 which contains Current Time Information, and field 1050 which contains Lapsed Play Time data.

In one embodiment of the invention, the data is transmitted from proxy server 118 to memory 132 and stored. Such data transmission may be performed, for example, at a predetermined frequency (e.g., once per second, per minute, per hour or per day), or when the available storage capacity of proxy server 118 reaches a predetermined threshold. In this embodiment, multiple command records may be compiled and stored in a user command table, denoted 1232 in FIG. 12. Each row in table 1232 represents a command record. Accordingly, table 1232 includes columns 1209-1 through 1209-5, which contains Terminal ID data, Command Type Information, Asset ID data, Current Time Information, and Lapsed Play Time data, respectively. In an alternative embodiment, processor 106 stores the command-related data in memory 108 of proxy server 118.

The received command is then forwarded to media processor 119 for accessing or manipulating a presentation of programming content (step 950). Thus, it should be noted that as far as processor 119 is concerned, server 118 performs a transparent read-and-forward function, unaffecting the received command.

Thus, suppose a user issues a command to select a recorded broadcast of a baseball game. The Select command is transmitted to interface 104 of proxy server 118, wherein server 118 reads the Terminal ID (e.g., 344323) of the set-top terminal from which the command was issued and information relating to the type of command that was received (in this instance, Select). The asset ID (e.g., asset 45325342 which corresponds to New York Yankees Baseball for Jun. 5, 2002) is also read from the user's command. In addition, the date and time that the command was received by server 118 is provided by clock 116 (e.g., 06/05/2002-08:00:26). The associated session data is also identified by proxy server 118—e.g., time 00:00:00 which relates to the Lapsed Play Time 1050 of the selected asset (which at this point is 00:00:00 because the user has only just selected the asset for playing). The data associated with the received command may then be compiled and stored as a command record, such as, in this example, record 1152 of FIG. 12.

If, for example, the user issued a fast-forward command, let's say, 2 minutes and 10 seconds later, the resulting record (1155) stored in memory 108 would indicate: the same Terminal ID as in record 1152 since the command issued from the same terminal (i.e., 344323), the issued Command Type (fast-forward), the same Asset ID as in record 1152 since the command relates to the same asset (i.e., 45325342), the Current Time Information as 2 minutes and 10 seconds later than that for record 1152 (i.e., 06/05/2002-08:02:36) and Lapsed Play Time (00:02:10).

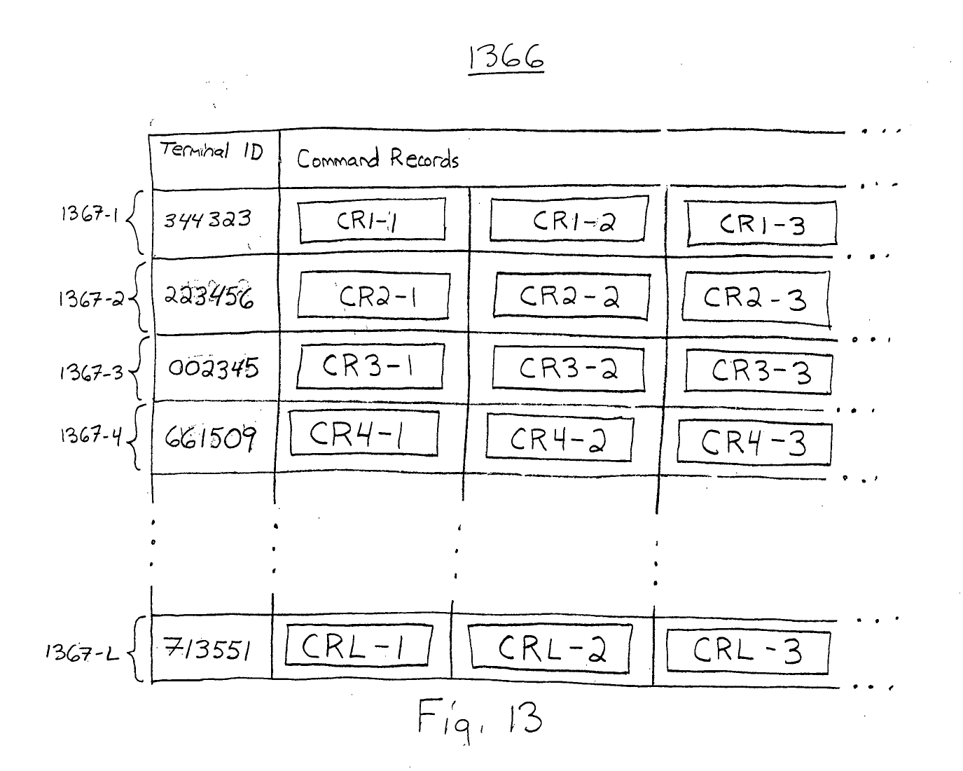

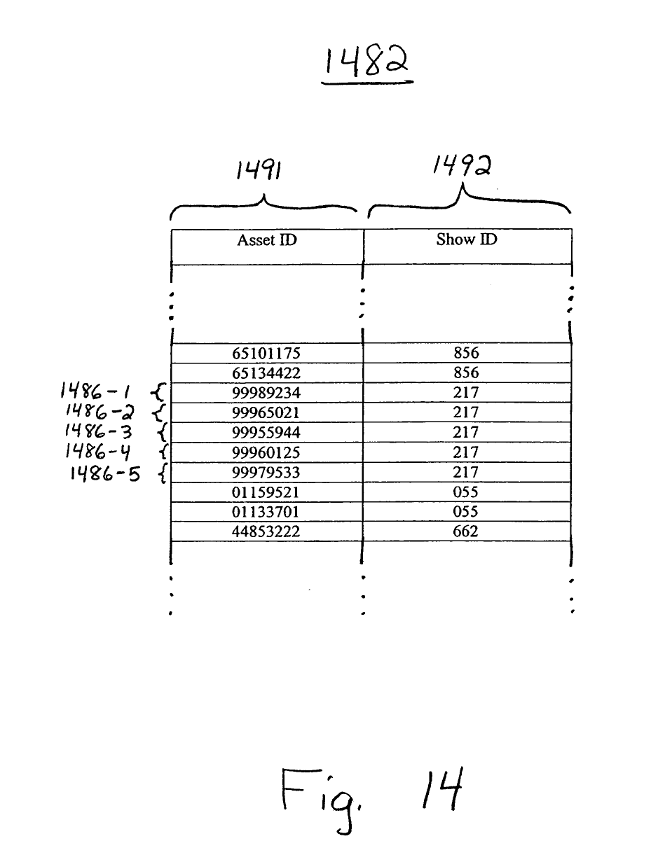

In one embodiment, data analyzer 133 may monitor the contents of user command table 1232, and extract and analyze selected data therefrom to provide useful information to users. For example, in one embodiment, data analyzer 133 may sort a selected subset of command records stored in table 1232 by Terminal ID to generate a user activity table reflecting the viewing activity of each terminal in system 100. For example, FIG. 13 illustrates a user activity database 1366 that may be generated by data analyzer 133. User activity database 1366 contains data representing the viewing activity of various terminals during a specified time period, e.g., during a one week period between June 1 and June 7. In this illustrative embodiment, database 1366 contains L files 1367-1 through 1367-L, each of which corresponds to a respective terminal in the system. Each file contains a Terminal ID identifying the set-top terminal to which the file corresponds. For example, file 1367-1 may correspond to set-top terminal 158-1 having a Terminal ID 344323. Each file also contains one or more command records each representing a command issued by the corresponding set-top terminal. For example, file 1367-1 includes command records CR1-1, CR1-2, CR1-3, etc., containing commands issued by terminal 158-1. In this embodiment, each command record may be stored in the format illustrated by FIG. 11. Accordingly (referring to FIG. 11), each command record comprises Terminal ID, Command Type Information, Asset ID, Current Time Information and Lapsed Play Time information fields. In this illustrative embodiment, command records within a file (e.g., file 1367-1) may be stored in chronological order. Thus, referring to file 1367-1, command record CR1-I was received by proxy server 118 from terminal 158-1 before command record CR1-2 was received, which in turn was received prior to command record CR1-3, etc. User activity database 1366 may be stored in memory 132.

In this illustrative embodiment, one or more assets attributed to the same show such as “Cheers,” “Friends,” “Everybody Loves Raymond,” etc., are assigned to a group. Assets attributed to the same show, identified by a show ID, are typically related. For example, assets containing episodes of “Cheers” may be grouped together and associated with a show ID, say, show ID “217,” while assets containing episodes of “Friends” may be grouped together and associated with a second show ID, etc. “Special” program such as a Superbowl game or a Presidential address may also be designated as a show; in such cases, the show may be associated with only one asset.

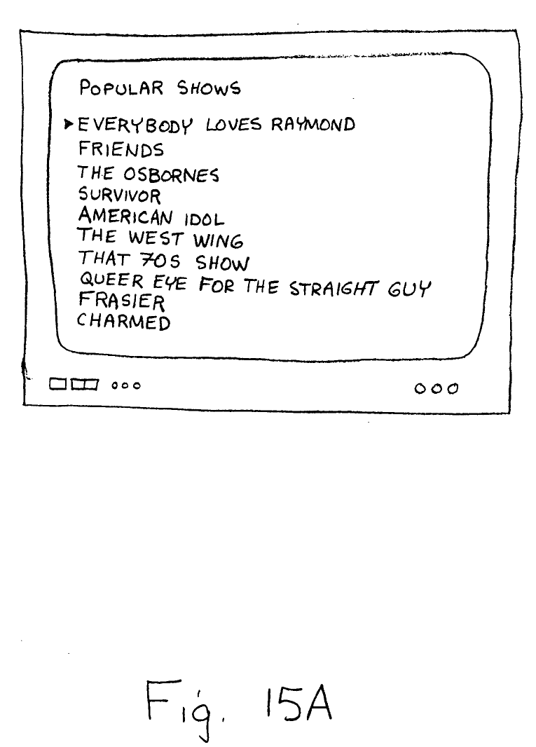

In this embodiment, a show table associating various Asset IDs with show IDs may be stored in memory 132. FIG. 14 illustrates show table 1482 that reflects the grouping of assets according to shows. Show table 1482 in this instance comprises columns 1491 and 1492 which include, respectively, a plurality of Asset IDs, and a plurality of show IDs. For example, referring to row 1486-1, Asset “99989234” is associated with show ID “217.” Accordingly, following the example given above, asset “99989234” may contain an episode of the TV show “Cheers.” Show table 1482 additionally indicates that each of the assets listed in rows 1486-2 through 1486-5 is associated with show ID “217;” accordingly, each of these assets may contain an episode of “Cheers.” In one embodiment, show table 1482 may be generated and stored in memory 132 by the cable operator. The cable operator may update show table 1482 periodically, e.g., once per week. In this example, show table 1482 may include all assets that are made available by the cable operator during a specified time period (e.g., during the one-week period from June 1 to June 7).

In accordance with an aspect of the invention, a viewer of a respective program is provided with a list of shows that are popular among viewers in the network. In one embodiment, when a program is playing, network controller 125 may cause a list of popular shows to be displayed one or more times during the presentation of the program. For example, the list may be shown automatically, or invoked by a viewer (e.g., by pressing a predetermined key on a remote control) during a commercial break or immediately after the program ends. In a second embodiment, the list may be shown automatically, or invoked by a viewer during the presentation of a program, e.g., in the lower right hand corner of the television screen.

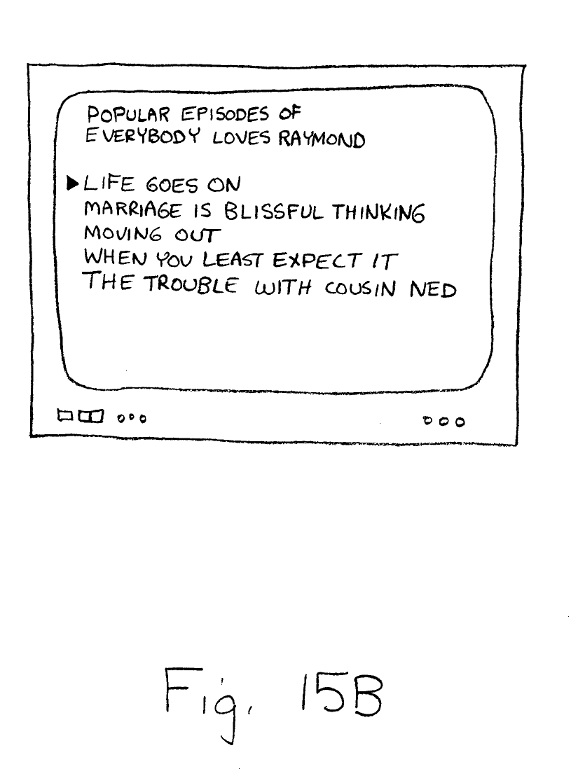

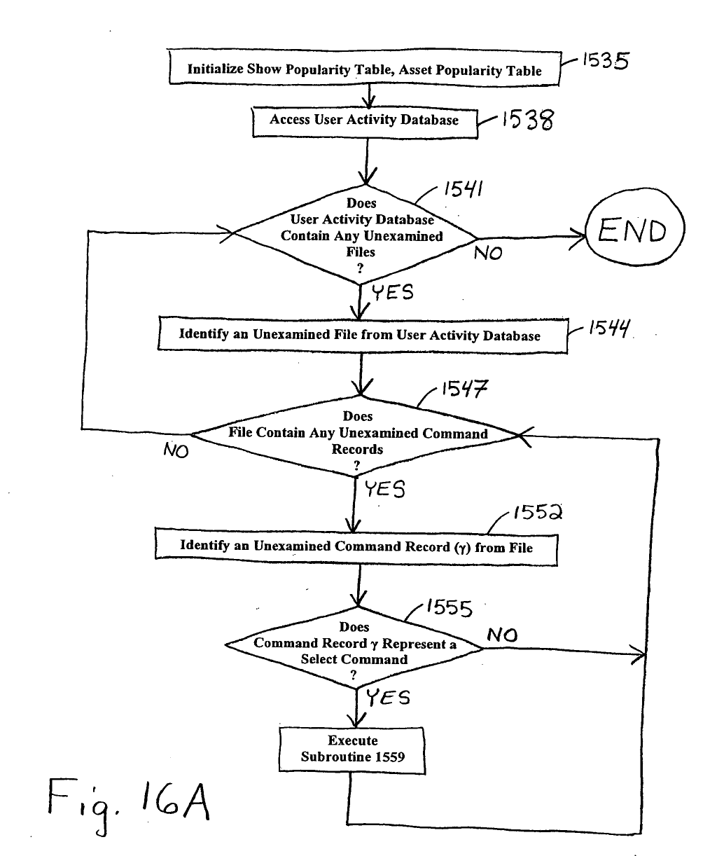

FIG. 15A illustrates a presentation of a list of popular shows in the first embodiment, with the most popular show listed first, e.g., “ELR,” followed by “Friends,” “The Osbornes” etc. Additionally, a user may select, or “click” on, a show to receive an additional listing of the most popular episodes of the selected show. In this instance, the user selects, say, “Everybody Loves Raymond” from the list shown in FIG. 15A, and in response, a list of the five most popular episodes of ELR is displayed (by title). FIG. 15B illustrates a presentation of a list of popular episodes of ELR, with the most popular episode listed first, e.g., “Life Goes On,” followed by “Marriage is Blissful Thinking,” etc. The list of episodes provided above is for illustrative purposes.

In one embodiment, network controller 125 may direct data analyzer 133 to generate a list of popular shows. Network controller 125 may request that a list be generated periodically, for example, once per day. In this embodiment, data analyzer 133 may determine the relative popularity of various shows based on how many times each show was viewed during a specified time period. For example, data analyzer 133 may determine the relative popularity of shows watched during a one-week period from June 1 to June 7 based on how many times each show was viewed during that period. After a list of popular shows is generated, data analyzer 133 may provide the list to network controller 125, which in turn may cause the list to be displayed on a user's television screen. Alternatively, data analyzer 133 may store the list in memory 132, and network controller 125 may access the list at a later time.

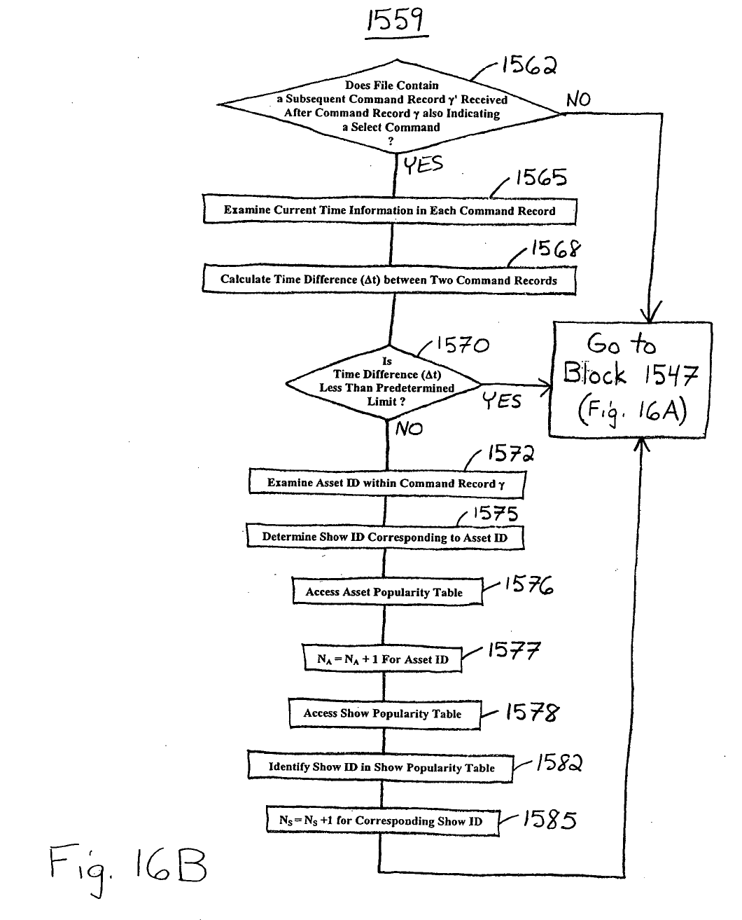

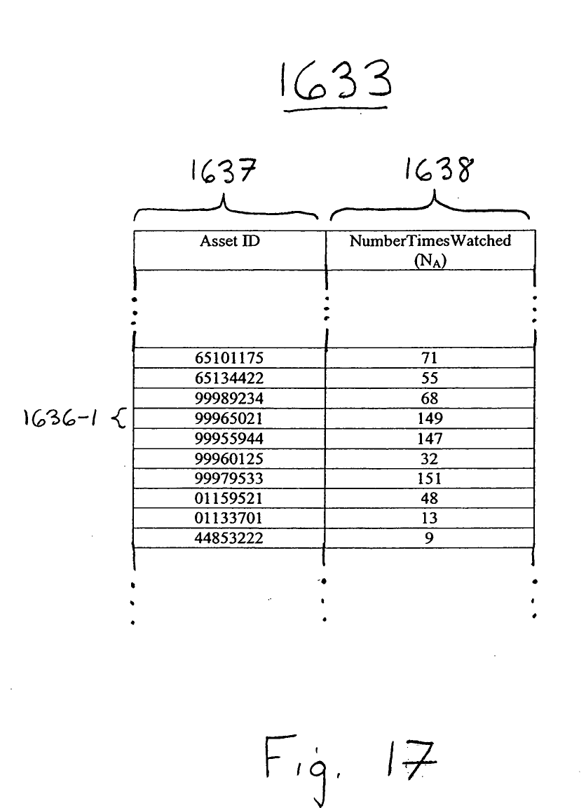

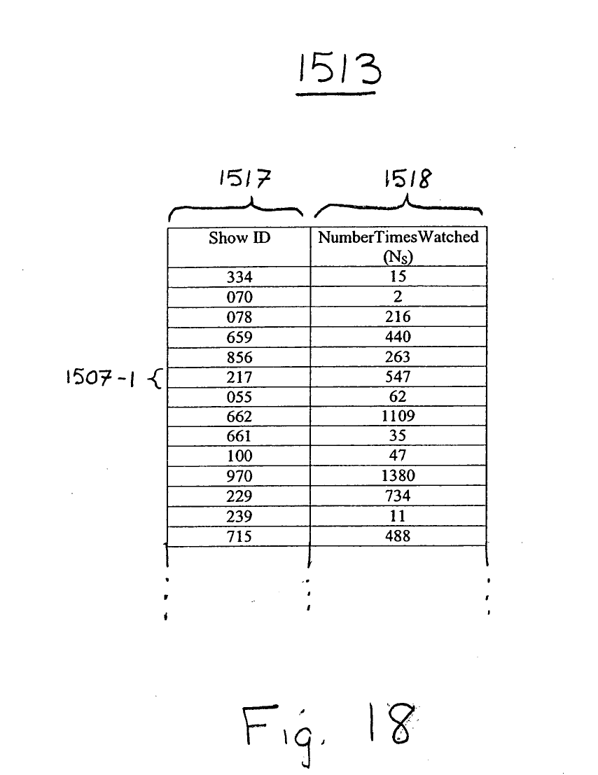

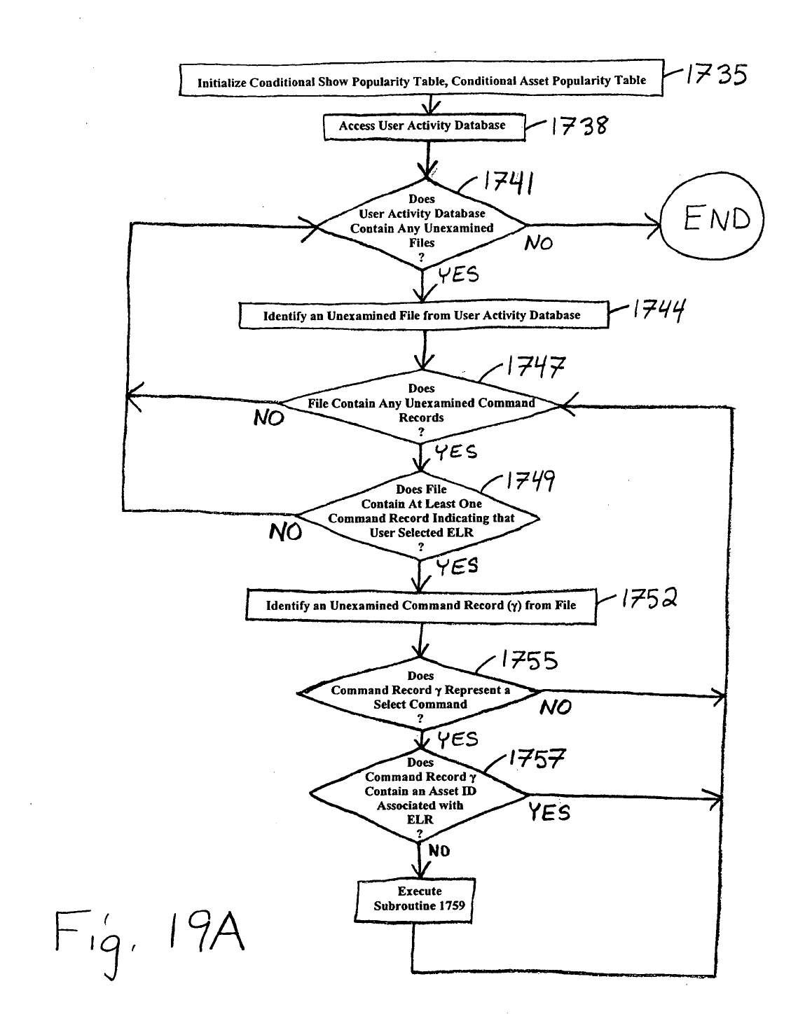

FIGS. 16A and16B are flowcharts jointly depicting a routine for determining the relative popularity of various shows and episodes by generating a show popularity table such as that shown in FIG. 18, and an asset popularity table such as that shown in FIG. 17. In this example, asset popularity table 1633 represents a list of assets available for viewing and indicates how many times each asset was accessed and viewed during the period from June 1 to June 7. Asset popularity table 1633 comprises two columns, 1637 and 1638. Column 1637 includes one or more Asset IDs each identifying an asset that was available for viewing during the period from June 1 to June 7. In one embodiment, the contents of column 1637 may be derived from the asset IDs listed in column 1491 of show table 1482. Column 1638 includes an integer value referred to as ‘NumberTimesWatched,’ or N_{A}, representing the number of times a respective asset was accessed and viewed during the specified period. For example, referring to row 1636-1, Asset 99965021 was accessed and viewed 149 times during the period from June 1 to June 7.

Similarly, referring to FIG. 18, show popularity table 1513 represents a list of shows available for viewing and indicates how many times each was accessed and viewed during the period from June 1 to June 7. Show popularity table 1513 comprises two columns, 1517 and 1518. Column 1517 includes one or more show IDs each representing a show that was available for viewing during the period from June 1 to June 7. It should be noted that a show ID listed in column 1517 represents all of the episodes of a respective show that were available. For example, referring to row 1507-1, show ID “217” represents all episodes of “Cheers” that were available for viewing during the week. In one embodiment, the contents of column 1517 may be derived from the show IDs listed in column 1492 of show table 1482. Column 1518 includes an integer value referred to as ‘NumberTimesWatched,’ or N_{S}, representing the number of times a respective show was accessed and viewed during the week. Referring to FIG. 16A, at step 1535 data analyzer 133 initializes asset popularity table 1633 and show popularity table 1513 by setting N_{A}=0 in each row of asset popularity table 1633, and by setting N_{S}=0 in each row of show popularity table 1513. In this embodiment, asset popularity table 1633 and show popularity table 1513 may be stored in memory 132.

In one embodiment, data analyzer 133 may compile information concerning each show's popularity by analyzing the viewing patterns reflected in user activity database 1366. Specifically, data analyzer 133 examines the commands issued by each terminal in the network in order to determine how many times each respective show was accessed and viewed. Accordingly, at step 1538, data analyzer 133 accesses user activity database 1366. Referring to block 1541, assuming that there is at least one unexamined file in user activity database 1366, data analyzer 133 proceeds to step 1544. Otherwise, if there are no unexamined files in user activity database 1366, the routine comes to an end.

At step 1544, data analyzer 133 identifies an unexamined file from user activity database 1366. For example, data analyzer 133 may identify file 1367-1, pertaining to terminal 158-1. Data analyzer examines file 1367-1 to determine which shows were accessed and viewed via terminal 158-1 during the period from June 1 to June 7. In some cases, the file may contain no command records, indicating that no command records were received from terminal 158-1 during the specified time period. In such case, as indicated by block 1547, the routine returns to step 1541 and another file, pertaining to a different terminal, may be selected and examined. It should be noted at this point that after all the files stored in user activity database 1366 have been examined, the routine comes to an end, as indicated by block 1541.

Continuing with the above example, if file 1367-1 contains at least one unexamined command record, then at step 1552, data analyzer 133 identifies from the file an unexamined command record (denoted γ) containing information concerning the type of a command issued by terminal 158-1. Data analyzer 133 may examine command records in chronological order, beginning with the command record representing the earliest received command, and proceeding chronologically thereafter.

In one embodiment, data analyzer 133 determines which shows were accessed and viewed via terminal 158-1, and for how long each show was viewed, by examining the Select commands issued by the terminal. Accordingly, in this embodiment, data analyzer 133 examines only those command records that indicate a Select command. Data analyzer 133 may determine the type of command in command record γ by scanning the content of field 1020 of command record γ. As indicated by block 1555, if the command record γ does not indicate a Select command, the routine returns to block 1547, and another command record may be examined. If the command record γ indicates a Select command, the routine proceeds to subroutine 1559 (illustrated in FIG. 16B).

Referring to FIG. 16B, instructed by subroutine 1559, data analyzer 133 determines how long the selected show was viewed, and to adjust the show's relative popularity value accordingly. As indicated by block 1562, if the file contains a command record γ′ received after the command record γ also indicating a Select command, the subroutine proceeds to step 1565. Otherwise, if there is no such subsequent command record γ′, the subroutine comes to an end. In such case, (referring again to FIG. 16A), data analyzer 133 returns to block 1547.

If the file contains a command record γ′, then at step 1565, data analyzer 133 determines how much time elapsed between the receipt of the first and second Select commands at headend 105 by examining the Current Time information T₁ associated with command record γ and the Current Time information T₂ associated with command record γ′. Referring back to FIG. 11, the Current Time information T₁ may be determined by examining field 1020 of command record γ, and the Current Time information T₂ may be determined by examining field 1020 of command record γ′. At step 1568, data analyzer 133 calculates the time difference Δt between the two command records, i.e., T₂−T₁ representing how much time elapsed between the receipt of the first Select command (indicated by command record γ) and the receipt of the second Select command (indicated by command record γ′). As indicated by block 1570, if the time difference Δt is less than a predetermined limit, the subroutine comes to an end, and data analyzer 133 may return to block 1547 of FIG. 16A. Such a predetermined limit is instituted to screen out “channel surfing” where a viewer switches from program to program, without meaningful appreciation of a program. In one embodiment, the predetermined limit may be thirty seconds. That is, if a user does not stay with a program for more than thirty seconds, the program is not deemed to have been accessed and thus not counted toward N_{A} or N_{S}. If the time difference Δt is equal to or greater than the predetermined limit, the routine proceeds to step 1572.

Referring to step 1572, data analyzer 133 examines the Asset ID indicated within field 1030 of the command record γ. At step 1575, data analyzer 133 determines the Show ID that corresponds to the Asset ID. In one embodiment, data analyzer 133 may make this determination by consulting show table 1482 (FIG. 14). At step 1576, data analyzer 133 accesses asset popularity table 1633. At step 1577, data analyzer 133 increases by one the value N_{A} corresponding to the respective Asset ID. At step 1578, data analyzer 133 accesses show popularity table 1513 and, at step 1582, identifies the show ID within show popularity table 1513 that corresponds to the Asset ID. At step 1585, data analyzer 133 increases by one the value N_{S} for the corresponding show ID. At this point, the subroutine comes to an end. Accordingly, data analyzer 133 returns to block 1547 of FIG. 16A and may continue to examine additional command records.

After all the files in user activity database 1366 have been examined, data analyzer 133 may examine show popularity table 1513 and select, say, the ten shows having the ten highest N_{S} values. These represent the ten most watched shows during the past week. Referring to FIG. 18, the values in column 1518 of popularity table 1513 illustrate one set of results that may be generated by the routine outlined in FIGS. 16A and 16B.

As discussed above, when a list of popular shows is displayed on a user's television screen, as illustrated in FIG. 15A, a user may select one of the shows listed, such as “Everybody Loves Raymond.” If a show is selected, network controller 125 may examine asset popularity table 1633 and cause a list of the assets (or episodes) to be shown on the user's television screen that are associated with the selected show and have the highest N_{A} values, as illustrated in FIG. 15B.

In accordance with a second aspect of the invention, a viewer of a particular show is provided with a list of other shows that are conditionally popular. For example, such other shows are popular among users who have watched the particular show recently. In one embodiment, when a program such as, for example, an episode of ELR, is playing on a user's television, network controller 125 causes a list of shows that are popular among those users who have recently watched ELR to be displayed on the television screen. The list may be displayed on the user's television screen at one or more selected times during the presentation of the program. In one embodiment, the list of shows may include shows that were popular among viewers of ELR during a specified time period, e.g., a one-week period from June 1 to June 7.

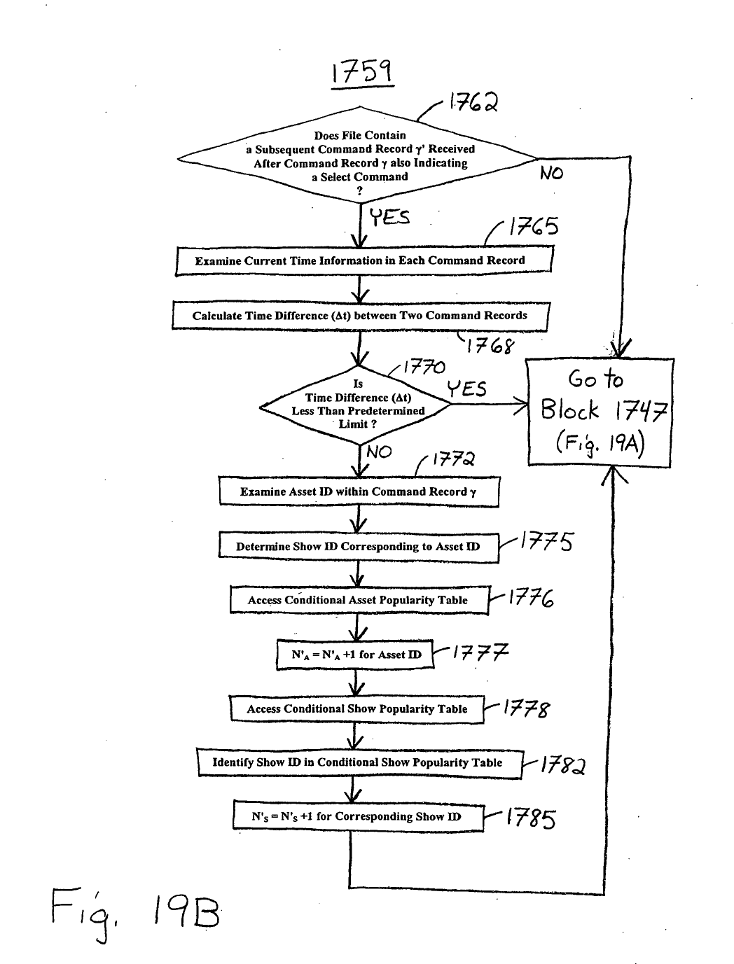

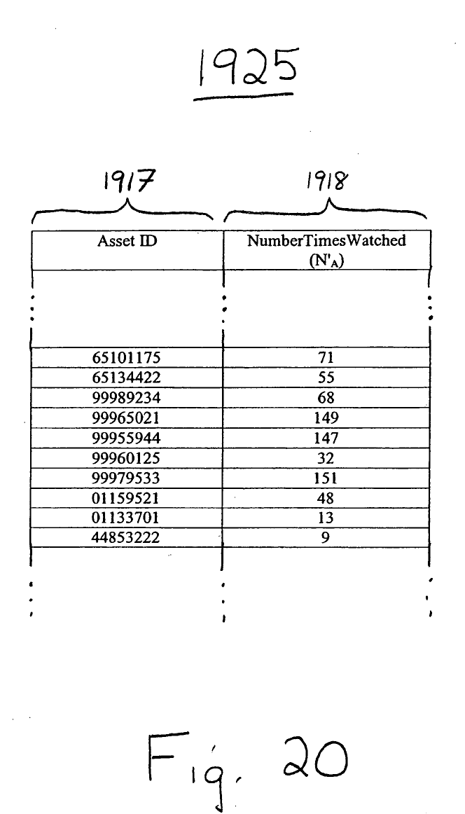

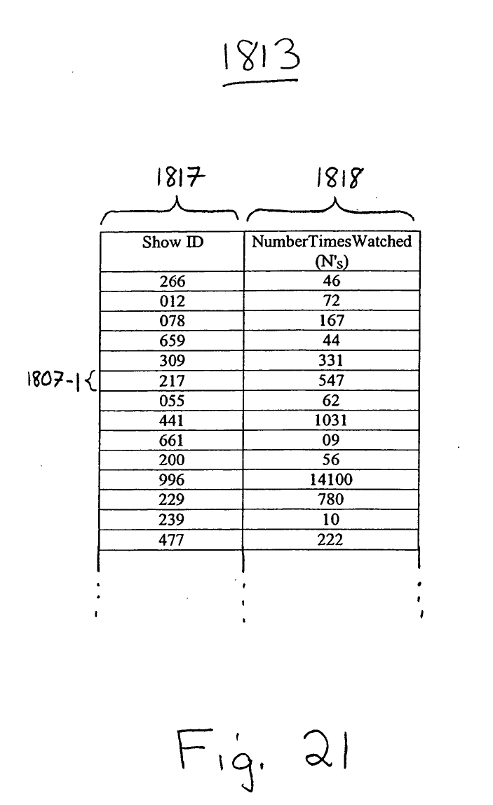

FIGS. 19A and 19B are flowcharts jointly depicting a routine for identifying a list of shows which are popular among viewers of a selected TV show. In this embodiment, data analyzer 133 may be programmed to generate a list of shows and episodes that are popular among users who watched ELR during a specified period, say, between June 1 and June 7. To that end, data analyzer 133 generates a conditional show popularity table such as that shown in FIG. 21, and a conditional asset popularity table such as that shown in FIG. 20.

Conditional asset popularity table 1925 illustratively comprises column 1917 which includes one or more Asset IDs each representing an asset that was available for viewing during the period from June 1 to June 7. In this embodiment, column 1917 does not include any asset associated with the show ID of the show that is currently being accessed and viewed by the user (ELR, in this instance). Column 1918 includes an integer value referred to as ‘NumberTimesWatched,’ or N′_{A}, representing the number of times a respective asset was viewed by ELR viewers during the specified period.

Conditional show popularity table 1813 illustratively comprises column 1817 which includes one or more show IDs each representing a show that was available for viewing during the period from June 1 to June 7. In this embodiment, column 1817 does not include the show ID for the show that is currently being viewed by the user (ELR, in this instance). It should be noted that a show ID listed in column 1817 represents all of the episodes of a respective show that were available during the one week period. For example, referring to row 1807-1, show ID “217” represents all episodes of “Cheers” that were available for viewing during the one-week period. In one embodiment, the contents of column 1817 may be derived from the show IDs listed in column 1492 of show table 1482. Column 1818 includes an integer value referred to as ‘NumberTimesWatched,’ or N'_{S}, representing the number of times a respective show was accessed and viewed by ELR viewers during the week.

Referring to FIG. 19A, at step 1735 data analyzer 133 initializes conditional asset popularity table 1925 and conditional show popularity table 1813 by setting N'_{A}=0 in each row of table 1925, and N'_{S}=0 in each row of table 1813. In this embodiment, conditional asset popularity table 1925 and conditional show popularity table 1813 may be stored in memory 132.

At step 1738, data analyzer 133 accesses user activity database 1366. Referring to block 1741, if there are no unexamined files in user activity database 1366, the routine comes to an end. Otherwise, if there is at least one unexamined file in user activity database 1366, data analyzer 133 proceeds to step 1744.

In this embodiment, data analyzer 133 identifies files that are associated with those users who accessed ELR at least once between June 1 and June 7. Accordingly, at step 1744, data analyzer 133 identifies an unexamined file, e.g., file 1367-1 associated with terminal 158-1, from user activity database 1366. Data analyzer examines file 1367-1 to determine which shows were accessed via terminal 158-1.

Referring to block 1747, if file 1367-1 contains at least one unexamined command record, then data analyzer 133 reads each of the command records stored in file 1367-1 to determine if the user at terminal 158-1 selected ELR at least once between June 1 and June 7. In one embodiment, data analyzer 133 examines the Command Type information (field 1020) and the Asset ID (field 1030) within each command record, and searches for a command record that indicates a Select command and contains an Asset ID associated with the ELR show. As indicated by block 1749, if file 1367-1 contains at least one such command record, indicating that the user selected ELR during the specified period, data analyzer 133 proceeds to step 1752. Otherwise, data analyzer 133 returns to step 1741, and another file, pertaining to a different terminal, may be selected and examined.

Assuming that a Select command for an episode of ELR is found in file 1367-1, data analyzer 133 again examines the command records stored in the file, to determine which shows were accessed and viewed via terminal 158-1, and for how long each respective show was viewed. Accordingly, in this embodiment, data analyzer 133 examines only those command records that indicate Select commands. Thus, at step 1752, data analyzer 133 identifies from the file a command record (command record γ) indicating a command issued by terminal 158-1. In one embodiment, data analyzer 133 examines command records in chronological order, beginning with the command record representing the earliest received command, and proceeding chronologically thereafter. Data analyzer 133 may determine the type of command that is represented by command record γ by examining the content of field 1020 of command record γ. As indicated by block 1755, if the command record γ does not contain a Select command, the routine returns to block 1747, and another command record may be examined. If the command record γ contains a Select command, the routine proceeds to block 1757. As indicated by block 1757, if command record γ contains an asset ID associated with the show ELR, the routine disregards the command record γ, and returns to block 1747, at which point another command record may be examined. Otherwise, the routine proceeds to subroutine 1759, illustrated in FIG. 19B.

Referring to FIG. 19B, instructed by subroutine 1759, data analyzer 133 to determine how long a show was viewed. As indicated by block 1762, if file 1367-1 contains a command record γ′ received after the command record γ also indicating a Select command, the subroutine proceeds to step 1765. If there is no such subsequently received command record, the subroutine comes to an end. In such case, (referring again to FIG. 19A), data analyzer 133 returns to block 1747.

If the file contains a subsequently received command record γ′, then at step 1765, data analyzer 133 determines how much time elapsed between the receipt of the first and second Select commands at headend 105 by examining the Current Time information T₁ associated with command record γ and the Current Time information T₂ associated with command record γ′. At step 1768, data analyzer 133 calculates the time difference Δt between the two command records, i.e., T₂−T₁. As indicated by block 1770, if the time difference Δt is less than a predetermined limit, the subroutine comes to an end, and data analyzer 133 may return to block 1747 of FIG. 19A. In one embodiment, the predetermined limit may be, for example, 30 seconds. If the time difference Δt is equal to or greater than the predetermined limit, the routine proceeds to step 1772.

Referring to step 1772, data analyzer 133 examines the Asset ID indicated within field 1030 of the command record γ. At step 1775, data analyzer 133 determines the Show ID that corresponds to the Asset ID. In one embodiment, data analyzer 133 may make this determination by consulting show table 1482. At step 1776, data analyzer 133 accesses conditional asset popularity table 1925 and, at step 1777, increases by one the NumberTimesWatched value N'_{A} corresponding to the Asset ID. At step 1778, data analyzer 133 accesses conditional show popularity table 1813 and, at step 1782, identifies the show ID within show popularity table 1813 that corresponds to the Asset ID. At step 1785, data analyzer 133 increases by one the value N'_{S} for the corresponding show ID. At this point, the subroutine comes to an end. Accordingly, data analyzer 133 returns to block 1747 of FIG. 19A and may continue to examine additional command records.

After all the files stored in user activity database 1366 have been examined, data analyzer 133 may examine conditional show popularity table 1813 and select, say, the ten shows having the ten highest N'_{S} values. These represent the ten shows that were most popular among the viewers of ELR during the period from June 1 to June 7. Referring to FIG. 21, the values in column 1818 of conditional show popularity table 1813 illustrate one set of results that may be generated by the routine outlined in FIGS. 19A and 19B. A list of these ten most popular shows may be displayed on the user's television screen at an appropriate moment during or after the transmission of an ELR show. A user may select one of the listed shows. In that case, network controller 125 may examine conditional asset popularity table 1925 and cause a list of the assets (or episodes) to be shown on the user's television screen that are associated with the selected show and have the highest N'_{A} values.

The foregoing merely illustrates the principles of the invention. It will thus be appreciated that those skilled in the art will be able to devise numerous other arrangements which embody the principles of the invention and are thus within its spirit and scope.

For example, in the above illustrative embodiment, the popularity of a first show (or episode) relative to a second show (or episode) is determined based on the relative numbers of times—N_{S}, N'_{S} (or N_{A}, N'_{A})—that viewers access the respective shows (or episodes) during a specified period. In a second embodiment of the invention, the popularity of a first show (or episode) relative to a second show (or episode) is determined based on the relative cumulative lengths of time that viewers spend on the respective shows (or episodes) during a specified period. Based on the disclosure heretofore, the cumulative length of time that viewers spend on a particular show (or episode) can readily be determined by summing all Δt's pertaining to that particular show (or episode) during the specified period. In this second embodiment, a first show (or episode) is said to be more popular than a second show (or episode) when ΣΔt pertaining to the first show (or episode) is larger than ΣΔt pertaining to the second show (or episode) during the specified period.

However, in a third embodiment of the invention, the popularity of a first show (or episode) relative to a second show (or episode) is determined based on a function of both the relative ΣΔt and numbers of times that viewers access the respective shows (or episodes) during a specified period. That is, in this third embodiment, both the cumulative length of time that the viewers spend on a particular show and the number of times that viewers access the particular show are factors in determining the popularity of the particular show (or episode). That is, in determining the popularity of a particular show (or episode), ΣΔt pertaining to the particular show (or episode) may be weighted by the number of times that the viewers access the particular show (or episode), or vice versa.

Further, in accordance with another aspect of the invention, the list of popular shows (or episodes) may be geographical. That is, a first list may be generated which pertains to a first region, e.g., Northeastern region, while a second list may be generated which pertains to a second region, e.g., Midwest. Each regional list may be derived in accordance with the invention from only those command records originating from the set-top terminals in the particular region.

Finally, system 100 is disclosed herein in a form in which various functions are performed by discrete functional blocks. However, any one or more of these functions could equally well be embodied in an arrangement in which the functions of any one or more of those blocks or indeed, all of the functions thereof, are realized, for example, by one or more appropriately programmed processors.

What is claimed is:

1. A system for providing information through a communications network, comprising:
an interface for receiving commands from a plurality of terminals through the communications network, the commands being initiated by users at the terminals;
a server responsive to the commands for affecting presentations of programming content to the users at the terminals, data being collected which concerns a subset of the received commands which relate to the users' accessing selected programs, the received commands in the subset comprising program identifiers identifying the selected programs, respectively; and
a processing unit for analyzing at least the collected data to generate a viewing pattern of the users, information which concerns the viewing pattern being provided through the communications network.

2. The system of claim 1 wherein the viewing pattern is generated as a function of at least the numbers of times the respective selected programs are accessed in a specified period.

3. The system of claim 1 wherein the viewing pattern is generated as a function of at least the lengths of time during which contents of the respective selected programs are received by the terminals in a specified period.

4. The system of claim 1 wherein the information concerning the viewing pattern includes a list of programs ordered by their relative popularity.

5. The system of claim 4 wherein a user at the at least one terminal is allowed to choose one of the programs in the list to access.

6. The system of claim 5 wherein the chosen program includes a selected entertainment show.

7. The system of claim 5 wherein the chosen program includes a selected episode of an entertainment show.

8. The system of claim 1 wherein the plurality of terminals are selected based on previous access by the terminals to a particular program.

9. The system of claim 8 wherein the information concerning the viewing pattern is provided during a presentation the particular program.

10. The system of claim 8 wherein the information concerning the viewing pattern is provided at the conclusion of a presentation of the particular program.

11. The system of claim 1 wherein the plurality of terminals are selected based on their geographic locations.

12. The system of claim 1 wherein the communication network includes a cable network.

13. The system of claim 1 wherein the plurality of terminals include set-top terminals for receiving at least cable TV.

14. A method for use in a system for providing information through a communications network, comprising:
receiving commands initiated by users at a plurality of terminals through the communications network;
in response the received commands, affecting presentations of programming content to the users at the terminals;
repeating following (a) through (c) for each of the plurality of terminals in compiling statistics concerning a selected program:
(a) identifying a subset of the commands which originates from the terminal for accessing the selected program;
(b) based at least on the commands in the subset, determining whether content of the selected program is received by the terminal for at least a predetermined period after the terminal accesses the selected program; and
(c) revising the statistics when it is determined that the content of the selected program is received by the terminal for a least a predetermined period after the terminal accesses the selected program; and
providing information based at least on the statistics through the communications network.

15. The method of claim 14 wherein the statistics are revised to update the number of times the selected program is accessed in a specified period.

16. The method of claim 14 wherein the statistics are revised to update a cumulative length of time during which content of the selected program is received by ones of the terminals in a specified period.

17. The method of claim 14 wherein the information includes information concerning popularity of the selected program relative to other programs.

18. The method of claim 14 further comprising allowing a user at a terminal to choose a program to access based on the information.

19. The method of claim 18 wherein the chosen program includes a selected entertainment show.

20. The method of claim 18 wherein the chosen program includes a selected episode of an entertainment show.

21. The method of claim 14 wherein the plurality of terminals are selected based on previous access by the terminals to a particular program.

22. The method of claim 21 wherein the information is provided during a presentation the particular program.

23. The method of claim 21 wherein the information is provided at the conclusion of a presentation of the particular program.

24. The method of claim 14 wherein the plurality of terminals are selected based on their geographic locations.

25. A method for use in a system for providing information through a communications network, comprising:
receiving commands from a plurality of terminals through the communications network, the commands being initiated by users at the terminals;
in response to the commands, affecting presentations of programming content to the users at the terminals;
collecting data concerning a subset of the received commands which relate to the users' accessing selected programs, the received commands in the subset comprising program identifiers identifying the selected programs, respectively;
analyzing at least the collected data to generate a viewing pattern of the users; and
providing information concerning the viewing pattern through the communications network.

26. The method of claim 25 wherein the viewing pattern is generated as a function of at least the numbers of times the respective selected programs are accessed in a specified period.

27. The method of claim 25 wherein the viewing pattern is generated as a function of at least the lengths of time during which contents of the respective selected programs are received by the terminals in a specified period.

28. The method of claim 25 wherein the information concerning the viewing pattern includes a list of programs ordered by their relative popularity.

29. The method of claim 28 further comprising allowing a user at the at least one terminal to choose one of the programs in the list to access.

30. The method of claim 29 wherein the chosen program includes a selected entertainment show.

31. The method of claim 29 wherein the chosen program includes a selected episode of an entertainment show.

32. The method of claim 25 wherein the plurality of terminals are selected based on previous access by the terminals to a particular program.

33. The method of claim 32 wherein the information concerning the viewing pattern is provided during a presentation the particular program.

34. The method of claim 32 wherein the information concerning the viewing pattern is provided at the conclusion of a presentation of the particular program.

35. The method of claim 25 wherein the plurality of terminals are selected based on their geographic locations.

36. A method for providing information about programs, the method comprising:
receiving commands from users indicating selection of programs for viewing;
analyzing the commands received over a period of time to generate a list of popular programs; and
presenting the list of popular programs to a viewer.

37. The method of claim 36, wherein analyzing the commands to generate a list of popular programs includes:
storing command information indicating commands received over a period of time, a time being associated with at least some commands for which command information is stored;
determining which of a plurality of programs were selected during a period of time for which said list of popular programs is generated based on the stored command information and the commands which were received during said period of time.

38. The method of claim 36, wherein said step of analyzing commands includes:
determining an amount of time a program was viewed by a viewer; and
disregarding in said determination of popular programs, commands which resulted in viewing of said program for less than a predetermined period of time.

39. The method of claim 38, wherein said predetermined period of time is less than one minute.

40. The method of claim 38, wherein determining the amount of time a program was viewed by a viewer includes examining said stored command information to identify multiple program selection commands received from a user terminal within said predetermined period of time.

41. The method of claim 40, wherein said step of storing command information includes:
storing command information in a file including, for each received command corresponding to a terminal, a terminal identifier, a command type identifier and time information.

42. The method of claim 41, wherein said command type identifier information indicates the type of command, the types of commands for which information is stored including select commands, play commands and fast-forward commands.

43. The method of claim 37, wherein determining which of a plurality of programs were selected during a period of time for which said list of popular program includes
accessing stored information indicating commands issued by a plurality of different terminals; and
generating a count of the total number of times each of a plurality of different programs were watched during said period of time.

44. The method of claim 43,
wherein generating a count of the total number of times each of a plurality of different programs were watched includes incrementing an individual count corresponding to a program when it is determined that said program was presented at a terminal for a period of time exceeding a predetermined period of time; and
ordering the programs in said list based on the total number of times individual programs were watched during said period of time.

45. The method of claim 43, wherein said step of receiving commands is performed in a cable headend office.

46. The method of claim 36, wherein presenting the list of popular programs to a viewer includes presenting the list during a commercial break or immediately after a program ends.

47. The method of claim 36, wherein presenting the list of popular programs to a viewer includes presenting the list during presentation of a program, said list being presented a portion of the screen which is smaller than the portion used to present the program being viewed.

48. The method of claim 36, further comprising:
limiting said list of popular programs to programs which were viewed by other viewers who selected a program which was also selected by a user to whom the list is being presented.

49. The method of claim 36, wherein said list is presented as part of providing a network personal video recording service with interactive command capability.
